(19) United States
(12) Patent Application Publication
(10) Pub. No.: US 2022/0286842 A1
(43) Pub. Date: Sep. 8, 2022

(54) SIGNAL TRANSMITTING/RECEIVING METHOD IN WIRELESS COMMUNICATION SYSTEM

(71) Applicant: LG ELECTRONICS INC., Seoul (KR)

(72) Inventors: Giwon PARK, Seoul (KR); Youngdae LEE, Seoul (KR); Hanbyul SEO, Seoul (KR); Jongyoul LEE, Seoul (KR)

(73) Assignee: LG ELECTRONICS INC., Seoul (KR)

(21) Appl. No.: 17/597,389

(22) PCT Filed: Jul. 6, 2020
(86) PCT No.: PCT/KR2020/008801

§ 371 Date: Jan. 4, 2022

(30) Foreign Application Priority Data
Jul. 4, 2019 (KR) 10-2019-0080654

(51) Int. Cl. H04W 8/30; H04W 24/08; H04W 28/02

(52) U.S. Cl. CPC H04W 8/30; H04W 24/08; H04W 28/0278; H04W 92/18

(57) ABSTRACT

One embodiment is a method for carrying out an operation for a first UE in a wireless communication system, the method comprising the steps of: receiving data from an upper layer; monitoring a radio link state with a second UE; and on the basis of the radio link state, detecting or declaring a radio link failure (RLF), wherein the data is determined to be untransmittable data on the basis of the RLF.

### TECHNICAL FIELD

The following description relates to a wireless communication system, and more particularly, to a method and apparatus related to data transmission of a sidelink user equipment (UE), when a radio link state is poor.

### BACKGROUND ART

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi carrier frequency division multiple access (MC-FDMA) system.

A wireless communication system uses various radio access technologies (RATs) such as long term evolution (LTE), LTE-advanced (LTE-A), and wireless fidelity (WiFi). 5th generation (5G) is such a wireless communication system. Three key requirement areas of 5G include (1) enhanced mobile broadband (eMBB), (2) massive machine type communication (mMTC), and (3) ultra-reliable and low latency communications (URLLC). Some use cases may require multiple dimensions for optimization, while others may focus only on one key performance indicator (KPI). 5G supports such diverse use cases in a flexible and reliable way.

eMBB goes far beyond basic mobile Internet access and covers rich interactive work, media and entertainment applications in the cloud or augmented reality (AR). Data is one of the key drivers for 5G and in the 5G era, we may for the first time see no dedicated voice service. In 5G, voice is expected to be handled as an application program, simply using data connectivity provided by a communication system. The main drivers for an increased traffic volume are the increase in the size of content and the number of applications requiring high data rates. Streaming services (audio and video), interactive video, and mobile Internet connectivity will continue to be used more broadly as more devices connect to the Internet. Many of these applications require always-on connectivity to push real time information and notifications to users. Cloud storage and applications are rapidly increasing for mobile communication platforms. This is applicable for both work and entertainment. Cloud storage is one particular use case driving the growth of uplink data rates. 5G will also be used for remote work in the cloud which, when done with tactile interfaces, requires much lower end-to-end latencies in order to maintain a good user experience. Entertainment, for example, cloud gaming and video streaming, is another key driver for the increasing need for mobile broadband capacity. Entertainment will be very essential on smart phones and tablets everywhere, including high mobility environments such as trains, cars and airplanes. Another use case is augmented reality (AR) for entertainment and information search, which requires very low latencies and significant instant data volumes.

One of the most expected 5G use cases is the functionality of actively connecting embedded sensors in every field, that is, mMTC. It is expected that there will be 20.4 billion potential Internet of things (IoT) devices by 2020. In industrial IoT, 5G is one of areas that play key roles in enabling smart city, asset tracking, smart utility, agriculture, and security infrastructure.

URLLC includes services which will transform industries with ultra-reliable/available, low latency links such as remote control of critical infrastructure and self-driving vehicles. The level of reliability and latency are vital to smart-grid control, industrial automation, robotics, drone control and coordination, and so on.

Now, multiple use cases will be described in detail.

5G may complement fiber-to-the home (FTTH) and cable-based broadband (or data-over-cable service interface specifications (DOCSIS)) as a means of providing streams at data rates of hundreds of megabits per second to giga bits per second. Such a high speed is required for TV broadcasts at or above a resolution of 4K (6K, 8K, and higher) as well as virtual reality (VR) and AR. VR and AR applications mostly include immersive sport games. A special network configuration may be required for a specific application program. For VR games, for example, game companies may have to integrate a core server with an edge network server of a network operator in order to minimize latency.

The automotive sector is expected to be a very important new driver for 5G, with many use cases for mobile communications for vehicles. For example, entertainment for passengers requires simultaneous high capacity and high mobility mobile broadband, because future users will expect to continue their good quality connection independent of their location and speed. Other use cases for the automotive sector are AR dashboards. These display overlay information on top of what a driver is seeing through the front window, identifying objects in the dark and telling the driver about the distances and movements of the objects. In the future, wireless modules will enable communication between vehicles themselves, information exchange between vehicles and supporting infrastructure and between vehicles and other connected devices (e.g., those carried by pedestrians). Safety systems may guide drivers on alternative courses of action to allow them to drive more safely and lower the risks of accidents. The next stage will be remote-controlled or self-driving vehicles. These require very reliable, very fast communication between different self-driving vehicles and between vehicles and infrastructure. In the future, self-driving vehicles will execute all driving activities, while drivers are focusing on traffic abnormality elusive to the vehicles themselves. The technical requirements for self-driving vehicles call for ultra-low latencies and ultra-high reliability, increasing traffic safety to levels humans cannot achieve.

Smart cities and smart homes, often referred to as smart society, will be embedded with dense wireless sensor networks. Distributed networks of intelligent sensors will identify conditions for cost- and energy-efficient maintenance of the city or home. A similar setup can be done for each home, where temperature sensors, window and heating controllers, burglar alarms, and home appliances are all connected wirelessly. Many of these sensors are typically characterized by low data rate, low power, and low cost, but for example, real time high definition (HD) video may be required in some types of devices for surveillance.

The consumption and distribution of energy, including heat or gas, is becoming highly decentralized, creating the need for automated control of a very distributed sensor network. A smart grid interconnects such sensors, using digital information and communications technology to gather and act on information. This information may include information about the behaviors of suppliers and consumers, allowing the smart grid to improve the efficiency, reliability, economics and sustainability of the production and distribution of fuels such as electricity in an automated fashion. A smart grid may be seen as another sensor network with low delays.

The health sector has many applications that may benefit from mobile communications. Communications systems enable telemedicine, which provides clinical health care at a distance. It helps eliminate distance barriers and may improve access to medical services that would often not be consistently available in distant rural communities. It is also used to save lives in critical care and emergency situations. Wireless sensor networks based on mobile communication may provide remote monitoring and sensors for parameters such as heart rate and blood pressure.

Wireless and mobile communications are becoming increasingly important for industrial applications. Wires are expensive to install and maintain, and the possibility of replacing cables with reconfigurable wireless links is a tempting opportunity for many industries. However, achieving this requires that the wireless connection works with a similar delay, reliability and capacity as cables and that its management is simplified. Low delays and very low error probabilities are new requirements that need to be addressed with 5G

Finally, logistics and freight tracking are important use cases for mobile communications that enable the tracking of inventory and packages wherever they are by using location-based information systems. The logistics and freight tracking use cases typically require lower data rates but need wide coverage and reliable location information.

A wireless communication system is a multiple access system that supports communication of multiple users by sharing available system resources (a bandwidth, transmission power, etc.). Examples of multiple access systems include a CDMA system, an FDMA system, a TDMA system, an OFDMA system, an SC-FDMA system, and an MC-FDMA system.

Sidelink (SL) refers to a communication scheme in which a direct link is established between user equipments (UEs) and the UEs directly exchange voice or data without intervention of a base station (BS). SL is considered as a solution of relieving the BS of the constraint of rapidly growing data traffic.

Vehicle-to-everything (V2X) is a communication technology in which a vehicle exchanges information with another vehicle, a pedestrian, and infrastructure by wired/wireless communication. V2X may be categorized into four types: vehicle-to-vehicle (V2V), vehicle-to-infrastructure (V2I), vehicle-to-network (V2N), and vehicle-to-pedestrian (V2P). V2X communication may be provided via a PC5 interface and/or a Uu interface.

As more and more communication devices demand larger communication capacities, there is a need for enhanced mobile broadband communication relative to existing RATs. Accordingly, a communication system is under discussion, for which services or UEs sensitive to reliability and latency are considered. The next-generation RAT in which eMBB, MTC, and URLLC are considered is referred to as new RAT or NR. In NR, V2X communication may also be supported.

FIG. 1 is a diagram illustrating V2X communication based on pre-NR RAT and V2X communication based on NR in comparison.

For V2X communication, a technique of providing safety service based on V2X messages such as basic safety message (BSM), cooperative awareness message (CAM), and decentralized environmental notification message (DENM) was mainly discussed in the pre-NR RAT. The V2X message may include location information, dynamic information, and attribute information. For example, a UE may transmit a CAM of a periodic message type and/or a DENM of an event-triggered type to another UE.

For example, the CAM may include basic vehicle information including dynamic state information such as a direction and a speed, vehicle static data such as dimensions, an external lighting state, path details, and so on. For example, the UE may broadcast the CAM which may have a latency less than 100 ms. For example, when an unexpected incident occurs, such as breakage or an accident of a vehicle, the UE may generate the DENM and transmit the DENM to another UE. For example, all vehicles within the transmission range of the UE may receive the CAM and/or the DENM. In this case, the DENM may have priority over the CAM.

In relation to V2X communication, various V2X scenarios are presented in NR. For example, the V2X scenarios include vehicle platooning, advanced driving, extended sensors, and remote driving.

For example, vehicles may be dynamically grouped and travel together based on vehicle platooning. For example, to perform platoon operations based on vehicle platooning, the vehicles of the group may receive periodic data from a leading vehicle. For example, the vehicles of the group may widen or narrow their gaps based on the periodic data.

For example, a vehicle may be semi-automated or full-automated based on advanced driving. For example, each vehicle may adjust a trajectory or maneuvering based on data obtained from a nearby vehicle and/or a nearby logical entity. For example, each vehicle may also share a dividing intention with nearby vehicles.

Based on extended sensors, for example, raw or processed data obtained through local sensor or live video data may be exchanged between vehicles, logical entities, terminals of pedestrians and/or V2X application servers. Accordingly, a vehicle may perceive an advanced environment relative to an environment perceivable by its sensor.

Based on remote driving, for example, a remote driver or a V2X application may operate or control a remote vehicle on behalf of a person incapable of driving or in a dangerous environment. For example, when a path may be predicted as in public transportation, cloud computing-based driving may be used in operating or controlling the remote vehicle. For example, access to a cloud-based back-end service platform may also be used for remote driving.

A scheme of specifying service requirements for various V2X scenarios including vehicle platooning, advanced driving, extended sensors, and remote driving is under discussion in NR-based V2X communication.

### DISCLOSURE

### Technical Problem

Embodiment(s) provides a method of dealing with data received from a higher layer, when radio link failure (RLF) occurs.

It will be appreciated by persons skilled in the art that the objects that could be achieved with the present disclosure are not limited to what has been particularly described hereinabove and the above and other objects that the present disclosure could achieve will be more clearly understood from the following detailed description.

### Technical Solution

According to an embodiment, a method of performing an operation for a first user equipment (UE) in a wireless communication system includes receiving data from a higher layer, monitoring a radio link state with a second UE, and detecting or declaring radio link failure (RLF) based on the radio link state. The data is determined to be unavailable data for transmission, based on the RLF.

According to an embodiment, a first UE in a wireless communication system includes at least one processor, and at least one computer memory operably coupled to the at least one processor and storing instructions which when executed, cause the at least one processor to perform operations. The operations include receiving data from a higher layer, monitoring a radio link state with a second UE, and detecting or declaring RLF based on the radio link state. The data is determined to be unavailable data for transmission, based on the RLF.

According to an embodiment, a processor for performing operations for a first UE in a wireless communication system is provided. The operations include receiving data from a higher layer, monitoring a radio link state with a second UE, and detecting or declaring RLF based on the radio link state. The data is determined to be unavailable data for transmission, based on the RLF.

According to an embodiment, a computer-readable storage medium storing a least one computer program including an instruction which when executed by at least one processor, causes the at least one processor to perform operations for a first UE is provided. The operations include receiving data from a higher layer, monitoring a radio link state with a second UE, and detecting or declaring RLF based on the radio link state. The data is determined to be unavailable data for transmission, based on the RLF.

The first UE may not trigger a buffer state report (BSR) for the data based on the RLF.

The first UE may not transmit an indication for the data to a lower layer based on the RLF.

The lower layer may be a medium access control (MAC) layer.

The data may be at least one of a packet data convergence protocol (PDCP) protocol data unit (PDU), a radio link control (RLC) PDU, RLC acknowledgement mode (AM) pending retransmission data, or a triggered RLC STATUS PDU.

The data may be related to the second UE.

The method may further include, based on the radio link state with the second UE being recovered within a predetermined time period after the detection of the RLF, determining the data to be available data for transmission.

The method may further include, based on the radio link state with the second UE being recovered, triggering a buffer state report (BSR) for the data.

The method may further include being allocated resources for the data based on the SBR by a base station.

The first UE may be a UE communicating with at least one of another UE, a UE related to an autonomous driving vehicle, a base station, or a network.

### Advantageous Effects

According to an embodiment, when radio link failure (RLF) occurs, a buffer status report (BSR) for sidelink data is not triggered, thereby preventing unnecessary resource consumption.

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### BRIEF DESCRIPTION OF THE DRAWINGS

The accompanying drawings, which are included to provide a further understanding of the disclosure, illustrate embodiments of the disclosure and together with the description serve to explain the principle of the disclosure.

FIG. 1 is a diagram illustrating vehicle-to-everything (V2X) communication based on pre-new radio access technology (NR) RAT and V2X communication based on NR in comparison.

FIG. 2 is a diagram illustrating the structure of a long term evolution (LTE) system according to an embodiment of the present disclosure.

FIG. 3 is a diagram illustrating user-plane and control-plane radio protocol architectures according to an embodiment of the present disclosure.

FIG. 4 is a diagram illustrating the structure of an NR system according to an embodiment of the present disclosure.

FIG. 5 is a diagram illustrating functional split between a next generation radio access network (NG-RAN) and a 5th generation core network (5GC) according to an embodiment of the present disclosure.

FIG. 6 is a diagram illustrating the structure of an NR radio frame to which embodiment(s) of the present disclosure is applicable.

FIG. 7 is a diagram illustrating a slot structure in an NR frame according to an embodiment of the present disclosure.

FIG. 8 is a diagram illustrating radio protocol architectures for sidelink (SL) communication according to an embodiment of the present disclosure.

FIG. 9 is a diagram illustrating radio protocol architectures for SL communication according to an embodiment of the present disclosure.

FIG. 10 is a diagram illustrating user equipments (UEs) which conduct V2X or SL communication between them according to an embodiment of the present disclosure.

FIG. 11 is a diagram illustrating a procedure of transmitting a radio resource control (RRC) message according to an embodiment of the present disclosure.

FIG. 12 is a flowchart illustrating embodiment(s).

FIGS. 13 to 22 are block diagrams illustrating various devices applicable to embodiment(s) of the present disclosure.

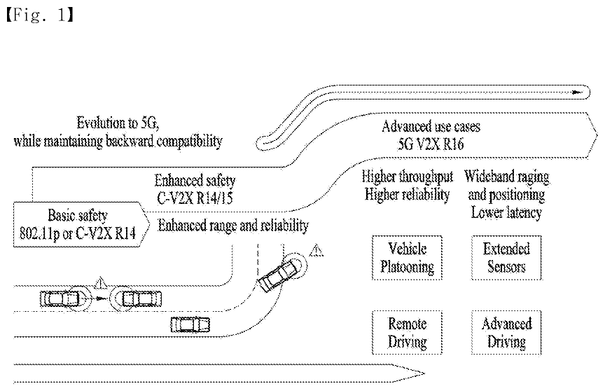

### BEST MODE

The embodiments In various embodiments of the present disclosure, “/” and “,” should be interpreted as “and/or”. For example, “A/B” may mean “A and/or B”. Further, “A, B” may mean “A and/or B”. Further, “A/B/C” may mean “at least one of A, B and/or C”. Further, “A, B, C” may mean “at least one of A, B and/or C”.

In various embodiments of the present disclosure, “or” should be interpreted as “and/or”. For example, “A or B” may include “only A”, “only B”, and/or “both A and B”. In other words, “or” should be interpreted as “additionally or alternatively”.

Techniques described herein may be used in various wireless access systems such as code division multiple access (CDMA), frequency division multiple access (FDMA), time division multiple access (TDMA), orthogonal frequency division multiple access (OFDMA), single carrier-frequency division multiple access (SC-FDMA), and so on. CDMA may be implemented as a radio technology such as universal terrestrial radio access (UTRA) or CDMA2000. TDMA may be implemented as a radio technology such as global system for mobile communications (GSM)/general packet radio service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, evolved-UTRA (E-UTRA), or the like. IEEE 802.16m is an evolution of IEEE 802.16e, offering backward compatibility with an IRRR 802.16e-based system. UTRA is a part of universal mobile telecommunications system (UMTS). 3rd generation partnership project (3GPP) long term evolution (LTE) is a part of evolved UMTS (E-UMTS) using evolved UTRA (E-UTRA). 3GPP LTE employs OFDMA for downlink (DL) and SC-FDMA for uplink (UL). LTE-advanced (LTE-A) is an evolution of 3GPP LTE.

A successor to LTE-A, 5th generation (5G) new radio access technology (NR) is a new clean-state mobile communication system characterized by high performance, low latency, and high availability. 5G NR may use all available spectral resources including a low frequency band below 1 GHz, an intermediate frequency band between 1 GHz and 10 GHz, and a high frequency (millimeter) band of 24 GHz or above.

While the following description is given mainly in the context of LTE-A or 5G NR for the clarity of description, the technical idea of an embodiment of the present disclosure is not limited thereto.

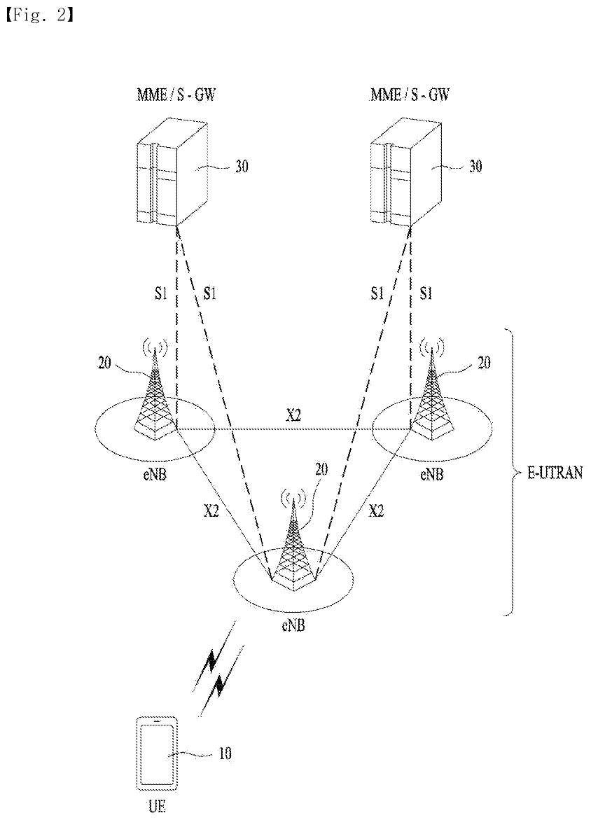

FIG. 2 illustrates the structure of an LTE system according to an embodiment of the present disclosure. This may also be called an evolved UMTS terrestrial radio access network (E-UTRAN) or LTE/LTE-A system.

Referring to FIG. 2, the E-UTRAN includes evolved Node Bs (eNBs) 20 which provide a control plane and a user plane to UEs 10. A UE 10 may be fixed or mobile, and may also be referred to as a mobile station (MS), user terminal (UT), subscriber station (SS), mobile terminal (MT), or wireless device. An eNB 20 is a fixed station communication with the UE 10 and may also be referred to as a base station (BS), a base transceiver system (BTS), or an access point.

eNBs 20 may be connected to each other via an X2 interface. An eNB 20 is connected to an evolved packet core (EPC) 39 via an S1 interface. More specifically, the eNB 20 is connected to a mobility management entity (MME) via an S1-MME interface and to a serving gateway (S-GW) via an S1-U interface.

The EPC 30 includes an MME, an S-GW, and a packet data network-gateway (P-GW). The MME has access information or capability information about UEs, which are mainly used for mobility management of the UEs. The S-GW is a gateway having the E-UTRAN as an end point, and the P-GW is a gateway having a packet data network (PDN) as an end point.

Based on the lowest three layers of the open system interconnection (OSI) reference model known in communication systems, the radio protocol stack between a UE and a network may be divided into Layer 1 (L1), Layer 2 (L2) and Layer 3 (L3). These layers are defined in pairs between a UE and an Evolved UTRAN (E-UTRAN), for data transmission via the Uu interface. The physical (PHY) layer at L1 provides an information transfer service on physical channels. The radio resource control (RRC) layer at L3 functions to control radio resources between the UE and the network. For this purpose, the RRC layer exchanges RRC messages between the UE and an eNB.

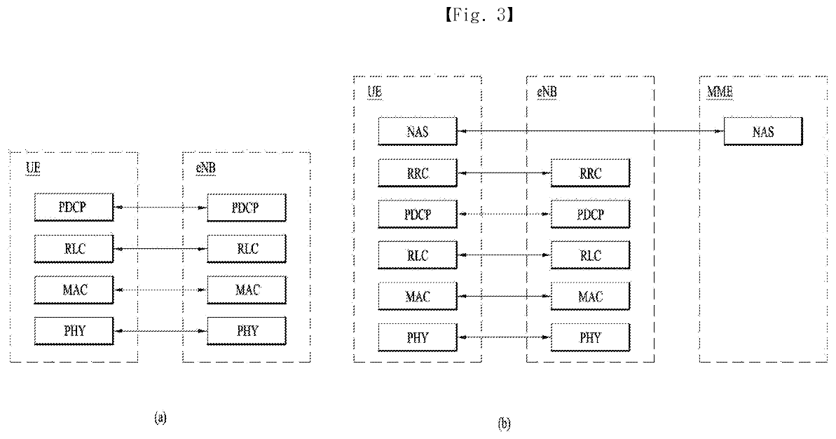

FIG. 3(a) illustrates a user-plane radio protocol architecture according to an embodiment of the disclosure.

FIG. 3(b) illustrates a control-plane radio protocol architecture according to an embodiment of the disclosure. A user plane is a protocol stack for user data transmission, and a control plane is a protocol stack for control signal transmission.

Referring to FIGS. 3(a) and 3(b), the PHY layer provides an information transfer service to its higher layer on physical channels. The PHY layer is connected to the medium access control (MAC) layer through transport channels and data is transferred between the MAC layer and the PHY layer on the transport channels. The transport channels are divided according to features with which data is transmitted via a radio interface.

Data is transmitted on physical channels between different PHY layers, that is, the PHY layers of a transmitter and a receiver. The physical channels may be modulated in orthogonal frequency division multiplexing (OFDM) and use time and frequencies as radio resources.

The MAC layer provides services to a higher layer, radio link control (RLC) on logical channels. The MAC layer provides a function of mapping from a plurality of logical channels to a plurality of transport channels. Further, the MAC layer provides a logical channel multiplexing function by mapping a plurality of logical channels to a single transport channel. A MAC sublayer provides a data transmission service on the logical channels.

The RLC layer performs concatenation, segmentation, and reassembly for RLC serving data units (SDUs). In order to guarantee various quality of service (QoS) requirements of each radio bearer (RB), the RLC layer provides three operation modes, transparent mode (TM), unacknowledged mode (UM), and acknowledged Mode (AM). An AM RLC provides error correction through automatic repeat request (ARQ).

The RRC layer is defined only in the control plane and controls logical channels, transport channels, and physical channels in relation to configuration, reconfiguration, and release of RBs. An RB refers to a logical path provided by L1 (the PHY layer) and L2 (the MAC layer, the RLC layer, and the packet data convergence protocol (PDCP) layer), for data transmission between the UE and the network.

The user-plane functions of the PDCP layer include user data transmission, header compression, and ciphering. The control-plane functions of the PDCP layer include control-plane data transmission and ciphering/integrity protection.

RB establishment amounts to a process of defining radio protocol layers and channel features and configuring specific parameters and operation methods in order to provide a specific service. RBs may be classified into two types, signaling radio bearer (SRB) and data radio bearer (DRB). The SRB is used as a path in which an RRC message is transmitted on the control plane, whereas the DRB is used as a path in which user data is transmitted on the user plane.

Once an RRC connection is established between the RRC layer of the UE and the RRC layer of the E-UTRAN, the UE is placed in RRC_CONNECTED state, and otherwise, the UE is placed in RRC_IDLE state. In NR, RRC_INACTIVE state is additionally defined. A UE in the RRC_INACTIVE state may maintain a connection to a core network, while releasing a connection from an eNB.

DL transport channels carrying data from the network to the UE include a broadcast channel (BCH) on which system information is transmitted and a DL shared channel (DL SCH) on which user traffic or a control message is transmitted. Traffic or a control message of a DL multicast or broadcast service may be transmitted on the DL-SCH or a DL multicast channel (DL MCH). UL transport channels carrying data from the UE to the network include a random access channel (RACH) on which an initial control message is transmitted and an UL shared channel (UL SCH) on which user traffic or a control message is transmitted.

The logical channels which are above and mapped to the transport channels include a broadcast control channel (BCCH), a paging control channel (PCCH), a common control channel (CCCH), a multicast control channel (MCCH), and a multicast traffic channel (MTCH).

A physical channel includes a plurality of OFDM symbol in the time domain by a plurality of subcarriers in the frequency domain. One subframe includes a plurality of OFDM symbols in the time domain. An RB is a resource allocation unit defined by a plurality of OFDM symbols by a plurality of subcarriers. Further, each subframe may use specific subcarriers of specific OFDM symbols (e.g., the first OFDM symbol) in a corresponding subframe for a physical DL control channel (PDCCH), that is, an L1/L2 control channel. A transmission time interval (TTI) is a unit time for subframe transmission.

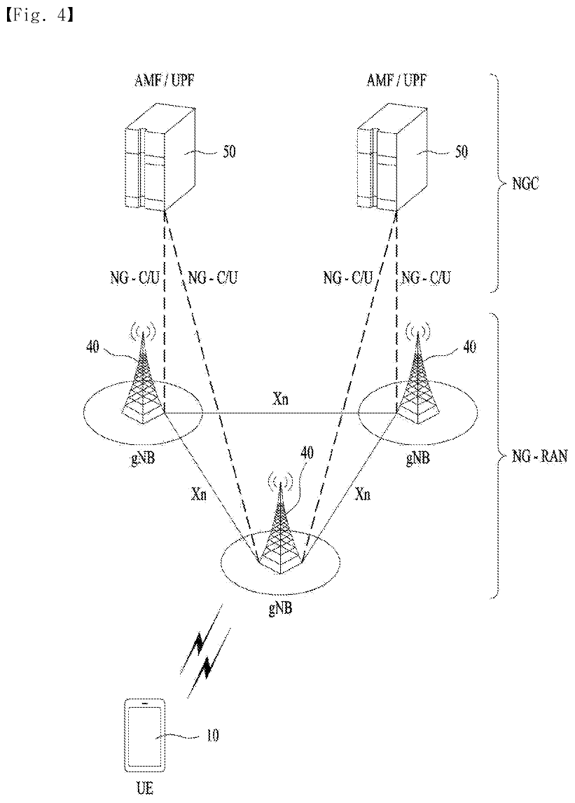

FIG. 4 illustrates the structure of an NR system according to an embodiment of the present disclosure.

Referring to FIG. 4, a next generation radio access network (NG-RAN) may include a next generation Node B (gNB) and/or an eNB, which provides user-plane and control-plane protocol termination to a UE. In FIG. 4, the NG-RAN is shown as including only gNB s, by way of example. A gNB and an eNB are connected to each other via an Xn interface. The gNB and the eNB are connected to a 5G core network (5GC) via an NG interface. More specifically, the gNB and the eNB are connected to an access and mobility management function (AMF) via an NG-C interface and to a user plane function (UPF) via an NG-U interface.

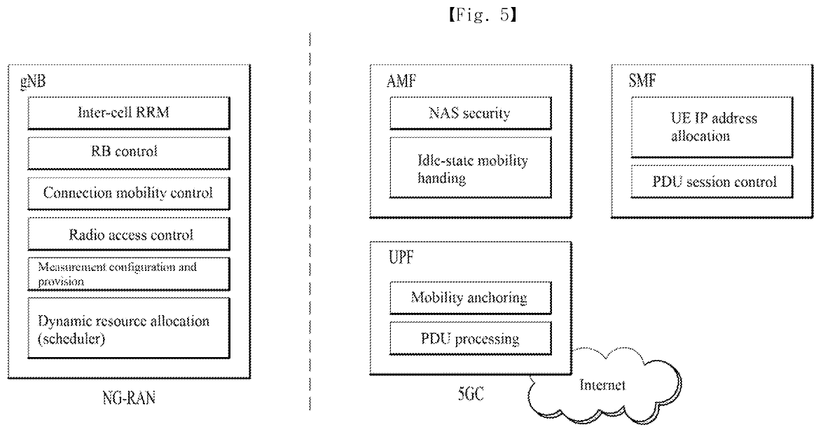

FIG. 5 illustrates functional split between the NG-RAN and the 5GC according to an embodiment of the present disclosure.

Referring to FIG. 5, a gNB may provide functions including inter-cell radio resource management (RRM), radio admission control, measurement configuration and provision, and dynamic resource allocation. The AMF may provide functions such as non-access stratum (NAS) security and idle-state mobility processing. The UPF may provide functions including mobility anchoring and protocol data unit (PDU) processing. A session management function (SMF) may provide functions including UE Internet protocol (IP) address allocation and PDU session control

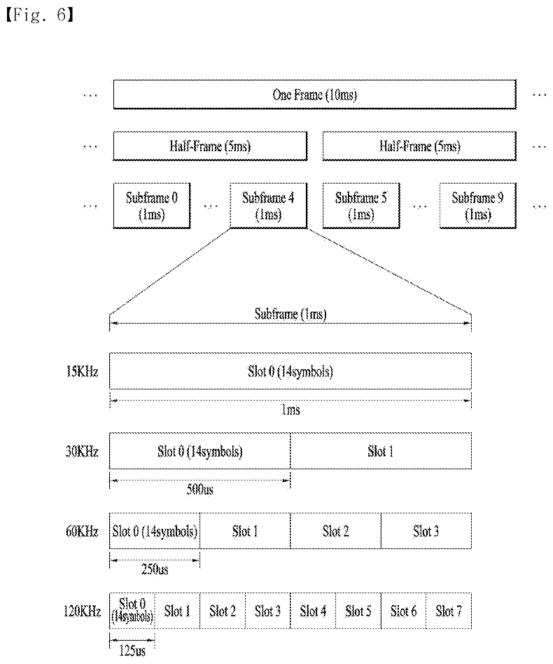

FIG. 6 illustrates a radio frame structure in NR, to which embodiment(s) of the present disclosure is applicable.

Referring to FIG. 6, a radio frame may be used for UL transmission and DL transmission in NR. A radio frame is 10 ms in length, and may be defined by two 5-ms half-frames. An HF may include five 1-ms subframes. A subframe may be divided into one or more slots, and the number of slots in an SF may be determined according to a subcarrier spacing (SCS). Each slot may include 12 or 14 OFDM(A) symbols according to a cyclic prefix (CP).

In a normal CP (NCP) case, each slot may include 14 symbols, whereas in an extended CP (ECP) case, each slot may include 12 symbols. Herein, a symbol may be an OFDM symbol (or CP-OFDM symbol) or an SC-FDMA symbol (or DFT-s-OFDM symbol).

Table 1 below lists the number of symbols per slot N^{slot}_{symb}, the number of slots per frame N^{frame,u}ₛₗₒₜ, and the number of slots per subframe N^{subframe,u}ₛₗₒₜ according to an SCS configuration μ in the NCP case.

TABLE 1

| | | | |
|---|---|---|---|
| SCS (15*2u) | N^{slot}_{symb} | N^{frame, u}ₛₗₒₜ | N^{subframe, u}ₛₗₒₜ |

| | | | | |
|---|---|---|---|---|
| 15 KHz | (u = 0) | 14 | 10 | 1 |
| 30 KHz | (u = 1) | 14 | 20 | 2 |
| 60 KHz | (u = 2) | 14 | 40 | 4 |
| 120 KHz | (u = 3) | 14 | 80 | 8 |
| 240 KHz | (u = 4) | 14 | 160 | 16 |

Table 2 below lists the number of symbols per slot, the number of slots per frame, and the number of slots per subframe according to an SCS in the ECP case.

TABLE 2

| SCS (15*2\hat{ }u) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

In the NR system, different OFDM(A) numerologies (e.g., SCSs, CP lengths, and so on) may be configured for a plurality of cells aggregated for one UE. Accordingly, the (absolute time) duration of a time resource including the same number of symbols (e.g., a subframe, slot, or TTI) (collectively referred to as a time unit (TU) for convenience) may be configured to be different for the aggregated cells.

In NR, various numerologies or SCSs may be supported to support various 5G services. For example, with an SCS of 15 kHz, a wide area in traditional cellular bands may be supported, while with an SCS of 30 kHz/60 kHz, a dense urban area, a lower latency, and a wide carrier bandwidth may be supported. With an SCS of 60 kHz or higher, a bandwidth larger than 24.25 GHz may be supported to overcome phase noise.

An NR frequency band may be defined by two types of frequency ranges, FR1 and FR2. The numerals in each frequency range may be changed. For example, the two types of frequency ranges may be given in [Table 3]. In the NR system, FR1 may be a “sub 6 GHz range” and FR2 may be an “above 6 GHz range” called millimeter wave (mmW).

TABLE 3

| Frequency | | |
|---|---|---|
| Range | Corresponding | Subcarrier |
| designation | frequency range | Spacing (SCS) |
| FR1 | 450 MHz-6000 MHz | 15, 30, 60 kHz |
| FR2 | 24250 MHz-52600 MHz | 60, 120, 240 kHz |

As mentioned above, the numerals in a frequency range may be changed in the NR system. For example, FR1 may range from 410 MHz to 7125 MHz as listed in [Table 4]. That is, FR1 may include a frequency band of 6 GHz (or 5850, 5900, and 5925 MHz) or above. For example, the frequency band of 6 GHz (or 5850, 5900, and 5925 MHz) or above may include an unlicensed band. The unlicensed band may be used for various purposes, for example, vehicle communication (e.g., autonomous driving).

TABLE 4

| Frequency | | |
|---|---|---|
| Range | Corresponding | Subcarrier |
| designation | frequency range | Spacing (SCS) |
| FR1 | 410 MHz-7125 MHz | 15, 30, 60 kHz |
| FR2 | 24250 MHz-52600 MHz | 60, 120, 240 kHz |

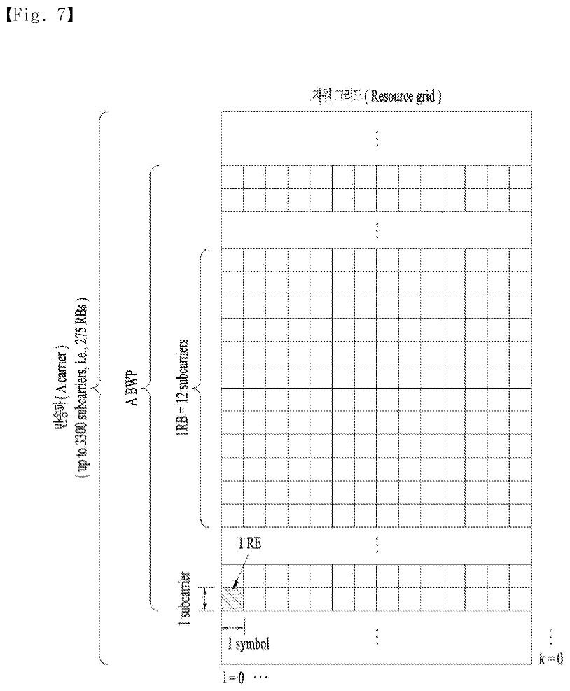

FIG. 7 illustrates a slot structure in an NR frame according to an embodiment of the present disclosure.

Referring to FIG. 7, a slot includes a plurality of symbols in the time domain. For example, one slot may include 14 symbols in an NCP case and 12 symbols in an ECP case. Alternatively, one slot may include 7 symbols in an NCP case and 6 symbols in an ECP case.

A carrier includes a plurality of subcarriers in the frequency domain. An RB may be defined by a plurality of (e.g., 12) consecutive subcarriers in the frequency domain. A bandwidth part (BWP) may be defined by a plurality of consecutive (physical) RBs ((P)RBs) in the frequency domain and correspond to one numerology (e.g., SCS, CP length, or the like). A carrier may include up to N (e.g., 5) BWPs. Data communication may be conducted in an activated BWP. Each element may be referred to as a resource element (RE) in a resource grid, to which one complex symbol may be mapped.

A radio interface between UEs or a radio interface between a UE and a network may include L1, L2, and L3. In various embodiments of the present disclosure, L1 may refer to the PHY layer. For example, L2 may refer to at least one of the MAC layer, the RLC layer, the PDCH layer, or the SDAP layer. For example, L3 may refer to the RRC layer.

Now, a description will be given of sidelink (SL) communication.

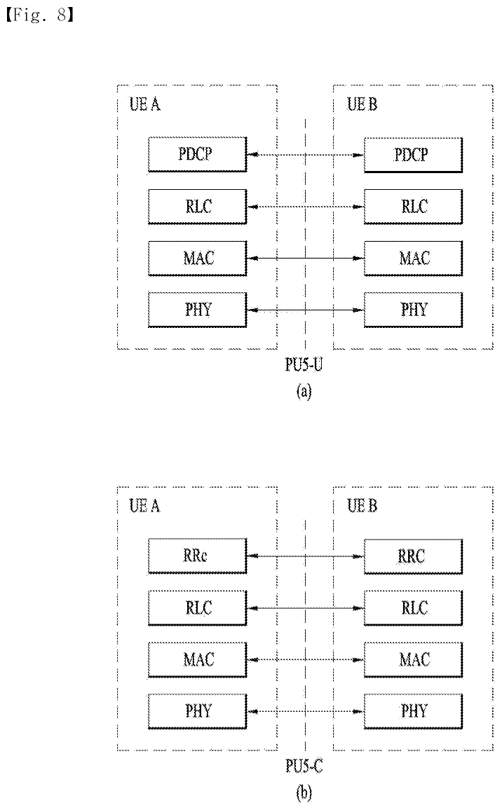

FIG. 8 illustrates a radio protocol architecture for SL communication according to an embodiment of the present disclosure. Specifically, FIG. 8(a) illustrates a user-plane protocol stack in LTE, and FIG. 8(b) illustrates a control-plane protocol stack in LTE.

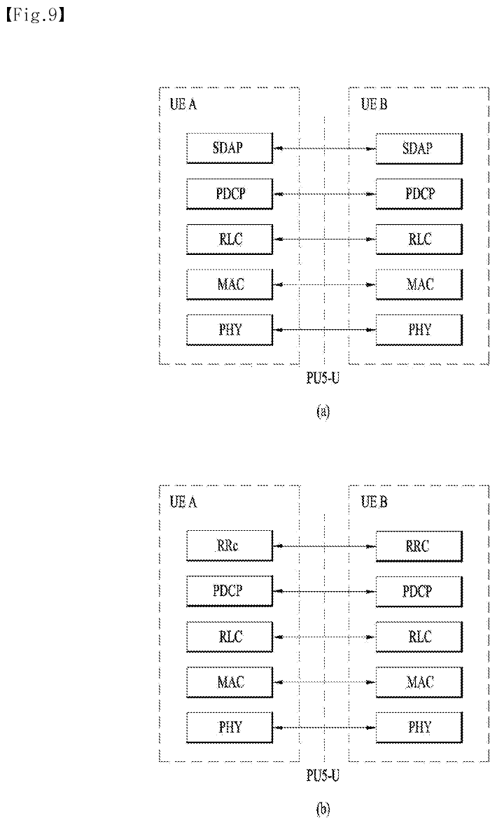

FIG. 9 illustrates a radio protocol architecture for SL communication according to an embodiment of the present disclosure. Specifically, FIG. 9(a) illustrates a user-plane protocol stack in NR, and FIG. 9(b) illustrates a control-plane protocol stack in NR.

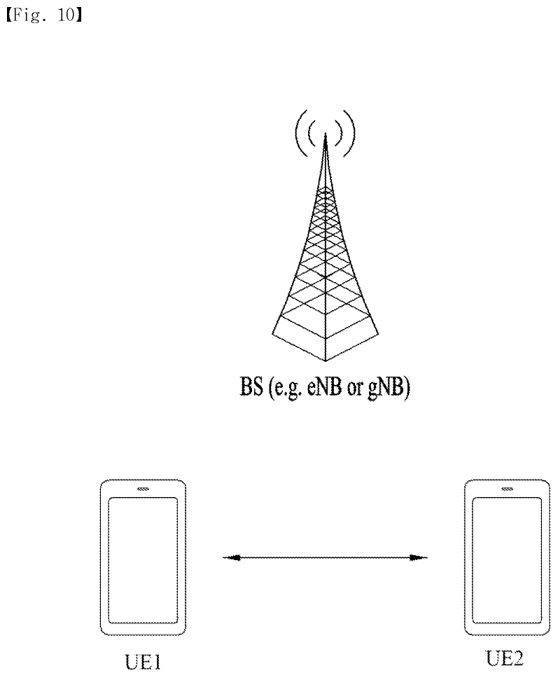

FIG. 10 illustrates UEs that conduct V2X or SL communication between them according to an embodiment of the present disclosure.

Referring to FIG. 10, the term “UE” in V2X or SL communication may mainly refer to a terminal of a user. However, when network equipment such as a BS transmits and receives a signal according to a UE-to-UE communication scheme, the BS may also be regarded as a kind of UE. For example, a first UE (UE1) may be a first device 100 and a second UE (UE2) may be a second device 200.

For example, UE1 may select a resource unit corresponding to specific resources in a resource pool which is a set of resources. UE1 may then transmit an SL signal in the resource unit. For example, UE2, which is a receiving UE, may be configured with the resource pool in which UE1 may transmit a signal, and detect the signal from UE1 in the resource pool.

When UE1 is within the coverage of the BS, the BS may indicate the resource pool to UE1. On the contrary, when UE1 is outside the coverage of the BS, another UE may indicate the resource pool to UE1, or UE1 may use a predetermined resource pool.

In general, a resource pool may include a plurality of resource units, and each UE may select one or more resource units and transmit an SL signal in the selected resource units.

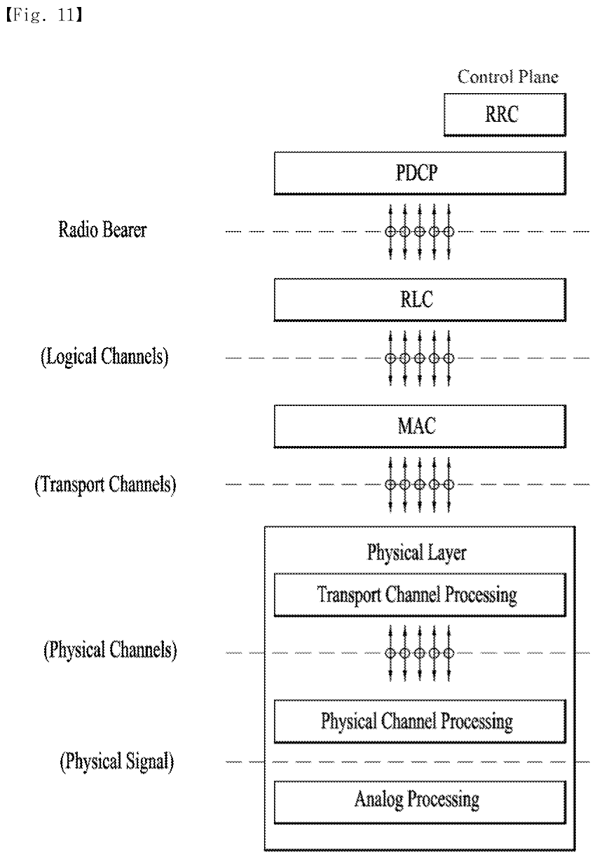

FIG. 11 illustrates a procedure of transmitting an RRC message according to an embodiment of the present disclosure.

Referring to FIG. 11, an RRC message generated by a transmitting UE may be delivered to the PHY layer via the PDCP layer, the RLC layer, and the MAC layer. The RRC message may be transmitted through a signaling radio bearer (SRB). The PHY layer of the transmitting UE may subject the received information to encoding, modulation, and antenna/resource mapping, and the transmitting UE may transmit the information to a receiving UE.

The receiving UE may subject the received information to antenna/resource demapping, demodulation, and decoding. The information may be delivered to the RRC layer via the MAC layer, the RLC layer, and the PDCP layer. Therefore, the receiving UE may receive the RRC message generated by the transmitting UE.

V2X or SL communication may be supported for a UE in RRC_CONNECTED mode, a UE in RRC_IDLE mode, and a UE in (NR) RRC_INACTIVE mode. That is, the UE in the RRC_CONNECTED mode, the UE in the RRC_IDLE mode and the UE in the (NR) RRC_INACTIVE mode may perform V2X or SL communication. The UE in the RRC_INACTIVE mode or the UE in the RRC_IDLE mode may perform V2X or SL communication by using a cell-specific configuration included in a V2X-specific SIB.

The RRC may be used to exchange at least a UE capability and an AS layer configuration. For example, UE1 may transmit its UE capability and AS layer configuration to UE2, and receive a UE capability and an AS layer configuration of UE2 from UE2. For UE capability delivery, an information flow may be triggered during or after PC5-S signaling for direct link setup.

SL radio link monitoring (SLM) will be described below.

For unicast AS-level link management, SL RLM and/or radio link failure (RLF) declaration may be supported. In RLC acknowledged mode (SL AM) of SL unicast, the RLF declaration may be triggered by an indication from the RLC indicating that a maximum number of retransmissions has been reached. An AS-level link status (e.g., failure) may need to be known to a higher layer. Unlike the RLM procedure for unicast, a groupcast-related RLM design may not be considered. The RLM and/or RLF declaration may not be needed between group members for groupcast.

For example, the transmitting UE may transmit an RS to the receiving UE, and the receiving UE may perform SL RLM using the RS. For example, the receiving UE may declare an SL RLF using the RS. For example, the RS may be referred to as an SL RS.

SL measurement and reporting will be described below.

For the purpose of QoS prediction, initial transmission parameter setting, link adaptation, link management, admission control, and so on, SL measurement and reporting (e.g., an RSRP or an RSRQ) between UEs may be considered in SL. For example, the receiving UE may receive an RS from the transmitting UE and measure the channel state of the transmitting UE based on the RS. Further, the receiving UE may report CSI to the transmitting UE. SL-related measurement and reporting may include measurement and reporting of a CBR and reporting of location information. Examples of CSI for V2X include a channel quality indicator (CQI), a precoding matrix index (PMI), a rank indicator (RI), an RSRP, an RSRQ, a path gain/pathloss, an SRS resource indicator (SRI), a CSI-RS resource indicator (CRI), an interference condition, a vehicle motion, and the like. For unicast communication, a CQI, an RI and a PMI or a part of them may be supported in a non-subband-based aperiodic CSI report based on the assumption of four or fewer antenna ports. The CSI procedure may not depend on a standalone RS. CSI reporting may be activated and deactivated depending on a configuration.

For example, the transmitting UE may transmit a channel state information-reference signal (CSI-RS) to the receiving UE, and the receiving UE may measure a CQI or RI using the CSI-RS. For example, the CSI-RS may be referred to as an SL CSI-RS. For example, the CSI-RS may be confined to PSSCH transmission. For example, the transmitting UE may transmit the CSI-RS in PSSCH resources to the receiving UE.

### Embodiment

When a UE monitors a radio link and determines that the state of the radio link is too poor for communication during communication (NR-Uu) between the UE and a BS, the UE may declare radio link failure (RLF). For example, when the following RLF conditions are satisfied, the UE may declare RLF.
The UE receives an OUT OF SYNC indication successively N times from the physical layer, and fails to receive an IN SYNC indication during a predetermined time period.
The UE fails an RACH procedure N times.
A maximum number of or more retransmissions occur in the RLC layer.

Like a connection between a UE and a BS, when the above-described RLF conditions are satisfied for an SL connection between SL UEs, RLF detection or LF declaration may be performed. When a UE detects RLF, the UE may start a timer for SL RLF, When a radio link state is not recovered until the timer expires (e.g., when an IN SYNC indication has not been received N times consecutively), the UE may declare RLF.

In LTE V2X SL communication, when a UE detects and/or declares RLF, pending data that has not been transmitted to a receiving UE may be processed as follows. For example, when a wireless layer (e.g., the PDCP or RLC layer) of the UE receives data from a higher layer (e.g., the application layer), the UE may determine that “available data for transmission” has been received. A PDCP entity and/or an RLC entity may deliver an “available data for transmission” indication indicating that there is available data for transmission to the MAC layer. Upon receipt of the “available data for transmission” indication from a higher layer (e.g., the PDCP or RLC layer), the MAC layer may initiate a resource allocation request process by triggering a buffer state report (BSR).

Conventionally, upon occurrence (detection or declaration) of RLF between a transmitting UE and a receiving UE, a PDCP entity or an RLC entity may deliver an “available data for transmission” indication to the MAC layer, when data transmitted from a higher layer exists at a wireless layer (e.g., PDCP or RLC) end or data is transmitted newly from the higher layer. A BSR may be triggered in the MAC layer, and the UE may request resources for transmitting the data received from the higher layer to the BS by transmitting an SR/BSR and may be allocated resources by the BS. However, when SL RLF has already occurred between the transmitting UE and the receiving UE, even though the transmitting UE transmits data to the receiving UE in the resources allocated by the BS, the receiving UE may not successfully receive the data from the transmitting UE. In this case, since the transmitting UE has requested and has been allocated unnecessary resources, the resources may be eventually wasted.

Therefore, the present disclosure proposes a method for preventing a transmitting UE from triggering a BSR for pending data in an SL RLF situation.

Proposal 1. When the transmitting UE declares SL RLF for a specific PC5-RRC connection, the transmitting UE may not consider data related to an SLRB of the (RLF-declared) PC5-RRC connection as “available data for transmission”.

That is, the MAC layer may not trigger a BSR by determining that higher-layer data (e.g., a PDCP PDU, RLC PDU, PDCP SDU, or RLC SDU) is not available data for transmission (that is, by determining that the higher-layer data is unavailable data for transmission).

In other words, even though the MAC layer receives an “available data for transmission” indication from the higher layer, the MAC layer may not determine the received higher-layer data as “available data for transmission” and thus not trigger a BSR.

For example, the PDCP entity may consider a PDCP PDU or a PDCP SDU as “available data for transmission” and transmit an “available data for transmission” indication to the MAC layer. Alternatively, the RLC entity may consider the PDCP PDU or the PDCP SDU as “available data for transmission” and transmit an “available data for transmission” indication to the MAC layer. Upon receipt of the “available data for transmission” indication, the MAC layer may not trigger a BSR by determining that the received PDCP PDU, RLC PDU, PDCP SDU, or RLC SDU is not available data (i.e., determining that it is unavailable data for transmission).

Proposals 1-1 to 1-6 below may be embodiments applicable together with Proposal 1 or independently of Proposal 1.

Proposal 1-1. When the transmitting UE declares SL RLF for a specific PC5-RRC connection, the transmitting UE may not consider an RLC PDU or RLC SDU related to an SLRB of the (RLF-declared) PC5-RRC connection to be “available data for transmission”.

That is, when the transmitting UE declares RLF, the RLC entity of the UE may not consider an RLC PDU or an RLC SDU to be “available data for transmission” and may not transmit an “available data for transmission” indication to the MAC layer. For example, the RLC entity may not transmit an RLC data volume (the amount of available data for transmission in the RLC entity) to the MAC layer. Therefore, the MAC layer may not trigger the BSR because it has not received the “available data for transmission” indication from the RLC entity.

Proposal 1-2. When the transmitting UE declares SL RLF for a specific PC5-RRC connection, the transmitting UE may not consider RLC AM bending retransmission data related to an SLRB of the (RLF-declared) PC5-RRC connection to be “available data for transmission”.

That is, when the transmitting UE declares RLF, the RLC entity of the UE may not consider RLC AM pending retransmission data to be “available data for transmission” and may not transmit an “available data for transmission” indication to the MAC layer. For example, the RLC entity may not transmit an RLC data volume (the amount of available data for transmission in the RLC entity) to the MAC layer. Therefore, the MAC layer may not trigger the BSR because it has not received the “available data for transmission” indication from the RLC entity.

Proposal 1-3. When the transmitting UE declares SL RLF for a specific PC5-RRC connection, the transmitting UE may not consider an RLC STATUS PDU related to an SLRB of the (RLF-declared) PC5-RRC connection to be “available data for transmission”.

That is, when the transmitting UE declares RLF, the RLC entity of the UE may not consider a triggered RLC STATUS PDU to be “available data for transmission” and may not transmit an “available data for transmission” indication to the MAC layer. For example, the RLC entity may not transmit an RLC data volume (the amount of available data for transmission in the RLC entity) to the MAC layer. Therefore, the MAC layer may not trigger the BSR because it has not received the “available data for transmission” indication from the RLC entity.

Proposal 1-4. When the transmitting UE declares SL RLF for a specific PC5-RRC connection, the transmitting UE may not consider a PDCP PDU or PDCP SDU related to an SLRB of the (RLF-declared) PC5-RRC connection to be “available data for transmission”.

That is, when the transmitting UE declares RLF, the PDCP entity of the UE may not consider a PDCP PDU or a PDCP SDU to be “available data for transmission” and may not transmit an “available data for transmission” indication to the MAC layer. For example, the PDCP entity may not transmit a PDCP data volume (the amount of available data for transmission in the RLC entity) to the MAC layer. Therefore, the MAC layer may not trigger the BSR because it has not received the “available data for transmission” indication from the PDCP entity.

Proposal 1-5. When the transmitting UE declares SL RLF for a specific PC5-RRC connection, the transmitting UE releases an SLRB of the (RLF-declared) PC5-RRC connection and terminates the PC5-RRC connection. Further, the transmitting UE may not consider data related to the SLRB of the (RLF-declared) PC5-RRC connection to be “available data for transmission”.

That is, the MAC layer may not trigger a BSR by determining that the higher-layer data (e.g., PDCP PDU or RLC PDU, or PDCP SDU or RLC SDU) is not “available data for transmission” (determining that the higher-layer data is unavailable data for transmission).

Proposal 1-6. When the transmitting UE declares SL RLF for a specific PC5-RRC connection, the transmitting UE may suspend an SLRB of the (RLF-declared) PC5-RRC connection during a predetermined time (i.e., a predefined RLF recovery time) and maintain the PC5-RRC connection. That is, the transmitting UE may not consider data related to the SLRB of the (RLF-declared) PC5-RRC connection to be “available data for transmission” for the time of suspending the data. When the RLF is recovered before the predefined RLF recovery time expires, the transmitting UE may consider the data related to the SLRB of the (RLF-declared) PC5-RRC connection for which the RLF has been recovered to be “available data for transmission”.

That is, upon occurrence of RLF, the MAC layer may not trigger a BSR by determining that the higher-layer data (e.g., PDCP PDU or RLC PDU, or PDCP SDU or RLC SDU) is not “available data for transmission” (i.e., determining the higher-layer data is unavailable data for transmission) during the predetermined time (the predefined RLF recovery time). When RLF is recovered within the predefined RLF recovery time, the MAC layer may trigger a BSR by determining that the higher-layer data (e.g., PDCP PDU or RLC PDU, or PDCP SDU or RLC SDU) is “available data for transmission”. Alternatively, upon occurrence of RLF, the higher wireless layer (PDCP or RLC) entity MAC layer may determine that the higher-layer data (e.g., PDCP PDU or RLC PDU, or PDCP SDU or RLC SDU) is not “available data for transmission” (i.e., determining the higher-layer data is unavailable data for transmission) during the predetermined time (the predefined RLF recovery time), and may not transmit an “available data for transmission” indication to the MAC layer so that the MAC layer may not consider the PDCP PDCU to be “available data for transmission”. For example, the entity may not transmit a PDCP data volume (the amount of available data for transmission in the PDCP entity) to the MAC layer. Further, the RLC entity of the UE may not consider the RLC PDU to be “available data for transmission”, and may not transmit an “available data for transmission” indication to the MAC layer. For example, the RLC entity may not transmit an RLC data volume (the amount of available data for transmission in the RLC entity) to the MAC layer.

That is, the MAC layer may not trigger a BSR by determining that the higher-layer data (e.g., PDCP PDU, RLC PDU, PDCP SDU, or RLC SDU) is not “available data for transmission” (i.e., determining the higher-layer data is unavailable data for transmission). When RLF is recovered within the predefined RLF recovery time, the MAC layer may trigger a BSR by determining that the higher-layer data (e.g., PDCP PDU or RLC PDU) is “available data for transmission”. Alternatively, the PDCP entity and the RLC entity may determine that the PDCP PDU and the RLC PDU are “available data for transmission” and transmit an “available data for transmission” indication to the MAC layer. For example, the PDCP entity may transmit a PDCP data volume (the amount of available data for transmission in the PDCP entity) to the MAC layer. Further, the RLC entity may transmit an RLC data volume (the amount of data available for transmission in the RLC entity) to the MAC layer.

Proposal 2. When the transmitting UE detects SL RLF for a specific PC5-RRC connection, the transmitting UE may not consider data related to an SLRB of the (RLF-detected) PC5-RRC connection as available data for transmission.

That is, the MAC layer may not trigger a BSR by determining that higher-layer data (e.g., a PDCP PDU, RLC PDU, PDCP SDU, or RLC SDU) is not available data for transmission (that is, by determining that the higher-layer data is unavailable data for transmission). In other words, upon detection RLF, even though the MAC layer receives an “available data for transmission” indication from the higher layer, the MAC layer may not determine the received higher-layer data as “available data for transmission” and thus not trigger a BSR.

For example, the PDCP entity may consider a PDCP PDU or a PDCP SDU as “available data for transmission” and transmit an “available data for transmission” indication to the MAC layer. Alternatively, the RLC entity may consider the PDCP PDU or the PDCP SDU as “available data for transmission” and transmit an “available data for transmission” indication to the MAC layer. Upon receipt of the “available data for transmission” indication, the MAC layer may not trigger a BSR by determining that the received PDCP PDU, RLC PDU, PDCP SDU, or RLC SDU is not available data (i.e., determining that it is unavailable data for transmission).

Proposals 2-1 to 2-5 below may be embodiments applicable together with Proposal 2 or independently of Proposal 2.

Proposal 2-1. When the transmitting UE detects SL RLF for a specific PC5-RRC connection, the transmitting UE may not consider an RLC PDU or RLC SDU related to an SLRB of the (RLF-detected) PC5-RRC connection to be “available data for transmission”.

That is, when the transmitting UE detects RLF, the RLC entity of the UE may not consider an RLC PDU or an RLC SDU to be “available data for transmission” and may not transmit an “available data for transmission” indication to the MAC layer. For example, the RLC entity may not transmit an RLC data volume (the amount of available data for transmission in the RLC entity) to the MAC layer. Therefore, the MAC layer may not trigger the BSR because it has not received the “available data for transmission” indication from the RLC entity.

Proposal 2-2. When the transmitting UE detects SL RLF for a specific PC5-RRC connection, the transmitting UE may not consider RLC AM bending retransmission data related to an SLRB of the (RLF-detected) PC5-RRC connection to be “available data for transmission”.

That is, when the transmitting UE detects RLF, the RLC entity of the UE may not consider RLC AM pending retransmission data to be “available data for transmission” and may not transmit an “available data for transmission” indication to the MAC layer. For example, the RLC entity may not transmit an RLC data volume (the amount of available data for transmission in the RLC entity) to the MAC layer. Therefore, the MAC layer may not trigger the BSR because it has not received the “available data for transmission” indication from the RLC entity.

Proposal 2-3. When the transmitting UE detects SL RLF for a specific PC5-RRC connection, the transmitting UE may not consider an RLC STATUS PDU related to an SLRB of the (RLF-detected) PC5-RRC connection to be “available data for transmission”.

That is, when the transmitting UE dectects RLF, the RLC entity of the UE may not consider a triggered RLC STATUS PDU to be “available data for transmission” and may not transmit an “available data for transmission” indication to the MAC layer. For example, the RLC entity may not transmit an RLC data volume (the amount of available data for transmission in the RLC entity) to the MAC layer. Therefore, the MAC layer may not trigger the BSR because it has not received the “available data for transmission” indication from the RLC entity.

Proposal 2-4. When the transmitting UE detects SL RLF for a specific PC5-RRC connection, the transmitting UE may not consider a PDCP PDU or PDCP SDU related to an SLRB of the (RLF-detected) PC5-RRC connection to be “available data for transmission”.

That is, when the transmitting UE detects RLF, the PDCP entity of the UE may not consider a PDCP PDU or a PDCP SDU to be “available data for transmission” and may not transmit an “available data for transmission” indication to the MAC layer. For example, the PDCP entity may not transmit an RLC data volume (the amount of available data for transmission in the RLC entity) to the MAC layer. Therefore, the MAC layer may not trigger the BSR because it has not received the “available data for transmission” indication from the PDCP entity.

Proposal 2-5. When the transmitting UE detects SL RLF for a specific PC5-RRC connection, the transmitting UE may suspend an SLRB of the (RLF-detected) PC5-RRC connection during a predetermined time (i.e., a predefined RLF recovery time) and maintain the PC5-RRC connection. That is, the transmitting UE may not consider data related to the SLRB of the (RLF-detected) PC5-RRC connection to be “available data for transmission” for the time of suspending the data. When the RLF is recovered before the predefined RLF recovery time expires, the transmitting UE may consider the data related to the SLRB of the (RLF-detected) PC5-RRC connection for which the RLF has been recovered to be “available data for transmission”.

That is, upon occurrence of RLF, the MAC layer may not trigger a BSR by determining that the higher-layer data (e.g., PDCP PDU or RLC PDU, or PDCP SDU or RLC SDU) is not “available data for transmission” (i.e., determining the higher-layer data is unavailable data for transmission) during the predetermined time (the predefined RLF recovery time). When RLF is recovered within the predefined RLF recovery time, the MAC layer may trigger a BSR by determining that the higher-layer data (e.g., PDCP PDU or RLC PDU, or PDCP SDU or RLC SDU) is “available data for transmission”. Alternatively, upon detection of RLF, the higher wireless layer (PDCP or RLC) entity MAC layer may determine that the higher-layer data (e.g., PDCP PDU or RLC PDU, or PDCP SDU or RLC SDU) is not “available data for transmission” (i.e., determining the higher-layer data is unavailable data for transmission) during the predetermined time (the predefined RLF recovery time). For example, the PDCP entity may not consider the PDCP PDU or the PDCP SDU to be “available data for transmission”, and may not transmit an “available data for transmission” indication to the MAC layer. Further, the PDCP entity may not transmit a PDCP data volume (the amount of available data for transmission in the PDCP entity) to the MAC layer. Further, the RLC entity of the UE may not consider the RLC PDU to be “available data for transmission”, and may not transmit an “available data for transmission” indication to the MAC layer. For example, the RLC entity may not transmit an RLC data volume (the amount of available data for transmission in the RLC entity) to the MAC layer.

That is, the MAC layer may not trigger a BSR by determining that the higher-layer data (e.g., PDCP PDU, RLC PDU, PDCP SDU, or RLC SDU) is not “available data for transmission” (i.e., determining the higher-layer data is unavailable data for transmission). When RLF is recovered within the predefined RLF recovery time, the MAC layer may trigger a BSR by determining that the higher-layer data (e.g., PDCP PDU or RLC PDU) is “available data for transmission”. Alternatively, the PDCP entity and the RLC entity may determine that the PDCP PDU and the RLC PDU are “available data for transmission” and transmit an “available data for transmission” indication to the MAC layer. For example, the PDCP entity may transmit a PDCP data volume (the amount of available data for transmission in the PDCP entity) to the MAC layer. Further, the RLC entity may transmit an RLC data volume (the amount of available data for transmission in the RLC entity) to the MAC layer.

In summary, when RLF is detected or declared between a transmitting UE and a receiving UE, a PDCP entity or an RLC entity of the transmitting UE may not determine higher-layer data to be “available data for transmission”. Accordingly, the PDCP entity or the RLC entity of the UE may not transmit an “available data for transmission” indication to the MAC layer. In addition, the MAC layer may not trigger a BSR because it has not received the “available data for transmission” indication. Alternatively, even when a MAC entity of the UE receives the “available data for transmission” indication from the higher layer, upon declaration or detection of RLF, the MAC entity may not determine the higher-layer data as “available data for transmission”. Accordingly, when RLF is detected or declared, the UE may not request unnecessary resources for higher-layer SL data according to the method or apparatus proposed by the present disclosure. Therefore, resource waste and signaling overhead may be prevented.

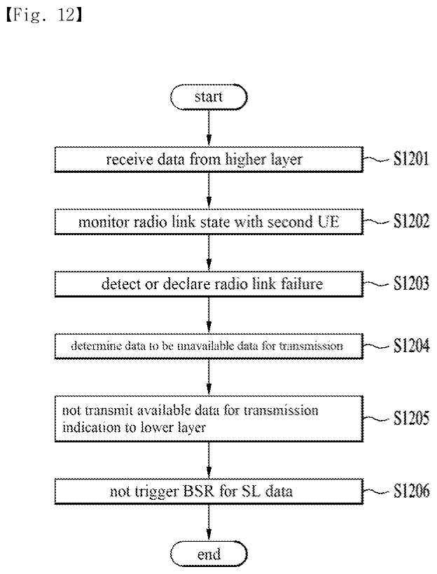

FIG. 12 is a flowchart illustrating embodiment(s) of the present disclosure.

A first UE may operate as the above-described transmitting UE, and a second UE may operate as the above-described receiving UE. The transmitting UE or the receiving UE is not limited to the function of transmitting or receiving a signal. That is, each of the transmitting UE and the receiving UE may perform both of signal transmission and signal reception.

Referring to FIG. 12, in step S1201, the first UE may receive data from a higher layer. More specifically, the first UE may transmit data for transmission to the second UE from the higher layer to a lower layer. For example, the higher layer of the UE may be the RRC, PDCP, or RLC layer. In addition, the lower layer of the UE may be the PDCP, RLC, or MAC layer. In addition, the data may be a packet data convergence protocol (PDCP) protocol data unit (PDU), a radio link control (RLC) PDU, RLC acknowledge mode (AM) pending retransmission data, or a triggered RLC STATUS PDU.

In step S1202, the first UE may monitor the state of a radio link with the second UE. The radio link state may be monitored in the physical layer of the first UE. The physical layer of the UE may identify OUT OF SYNC or IN SYNC and transmit an OUT OF SYNC indication or IN SYNC indication to the higher layer.

In step S1203, the first UE may detect or declare RLF based on the monitoring of the radio link state. When RLF is detected, the first UE may activate an SL RLF timer. When the UE fails to receive a threshold number of or more IN SYNC indications before expiration of the timer, the UE may declare RLF.

In step S1204, when RLF is detected or declared, the first UE may not determine data received from the higher layer to be available data for transmission. Alternatively, the first UE may determine the data to be unavailable data for transmission. In step S1205, the first UE may not transmit an available data for transmission indication indicating that there is available data for transmission to the lower layer. In step S1206, the first UE may not trigger a BSR for the data. Accordingly, the first UE may prevent unnecessary resource allocation and signaling overhead by transmitting no SR/BSR for data to be transmitted to the second UE to a BS.

When the RLF is detected, the first UE may activate a timer for RLF declaration. In addition, when the radio link state with the second UE is recovered within a preset timer expiration period, the first UE may determine the data to be available data for transmission. The first UE may then trigger a BSR for the data and transmit an SR/BSR to the BS to be allocated resources for transmission of the data to the second UE.

It may be assumed that the OUT OF SYNC indication described in the present disclosure may be transmitted from the physical layer to the higher layer, when the UE satisfies the following.
The BLER of a control channel decreases to or below a threshold.
The transmitting UE receives a threshold number or more HARQ NACKs from the receiving UE.
The receiving UE fails to receive a control channel (i.e., a channel carrying data channel scheduling information) from the transmitting UE, and thus does not a feedback to the transmitting UE.

Pending data described in the present disclosure may be an initial transmission packet or a retransmission packet.

Upon declaration or detection of RLC as proposed in the present disclosure, a wireless layer (e.g., PDCP or RLC) of a UE receives data from a higher layer, the wireless layer may determine the data to be available data for transmission, only when the following conditions are satisfied. Alternatively, the determination may be made regardless of the following conditions.
Condition 1) the latency budget of a data transmission being serviced is larger than a delay until transmission resources are allocated through a BS (the total time of an SR/BSR transmission, resource allocation from the BS, and an expected delay of transmission to a target UE).
Condition 2) the latency budget of a data transmission being serviced is larger than a total time taken for the UE to transmit data to the BS on UL (from the UE to the BS) via a Uu interface and for the BS to receive the data from the transmitting UE and transmit data to the UE on DL.

RLF detection and RLF declaration described in the present disclosure may be distinguished from each other in the following manner.

RLF Detection

When the UE receives an OUT OF SYNC indication N times consecutively from the physical layer, the UE determines that RLF has been detected. A radio link is maintained between UEs.

RLF Declaration

When the UE receives an OUT OF SYNC indication N times consecutively from the physical layer, the UE activates a timer. When the UE fails to receive an IN SYNC indication (i.e., a state in which the BLER of a control channel is equal to or greater than a threshold) from the physical layer, the UE declares RLF and disconnects the connection between the UEs.

A predefined RLF recovery time described in the present disclosure may refer to a specified time period during which a UE maintains a PC5-RRC connection without immediately terminating the PC5-RRC connection, when the UE declares RFL for the PC5-RRC connection. That is, when the RLF is not recovered within the predefined RLF recovery time, the UE may terminate the PC5-RRC connection. On the contrary, when the RLF is recovered within the predefined RLF recovery time, the UE may maintain the PC5-RRC connection.

According to embodiment(s) of the present disclosure, in an RLF detection or declaration situation, a UE is configured not to request resources for pending transmission data any longer. Therefore, the overhead of a transmission resource request procedure of the UE may be reduced. A BS does not unnecessarily allocate transmission resources that the UE may not use normally (even though the UE uses allocated resources, transmission failure occurs). Therefore, resources of the BS are not wasted.

Examples of Communication Systems Applicable to the Present Disclosure

The various descriptions, functions, procedures, proposals, methods, and/or operational flowcharts of the present disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

FIG. 13 illustrates a communication system 1 applied to the present disclosure.

Referring to FIG. 13, a communication system 1 applied to the present disclosure includes wireless devices, BSs, and a network. Herein, the wireless devices represent devices performing communication using RAT (e.g., 5G NR or LTE) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of things (IoT) device 100f, and an artificial intelligence (AI) device/server 400. For example, the vehicles may include a vehicle having a wireless communication function, an autonomous driving vehicle, and a vehicle capable of performing communication between vehicles. Herein, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. V2V/V2X communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as UL/DL communication 150a, sidelink communication 150b (or, D2D communication), or inter BS communication (e.g. relay, integrated access backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

Examples of Wireless Devices Applicable to the Present Disclosure

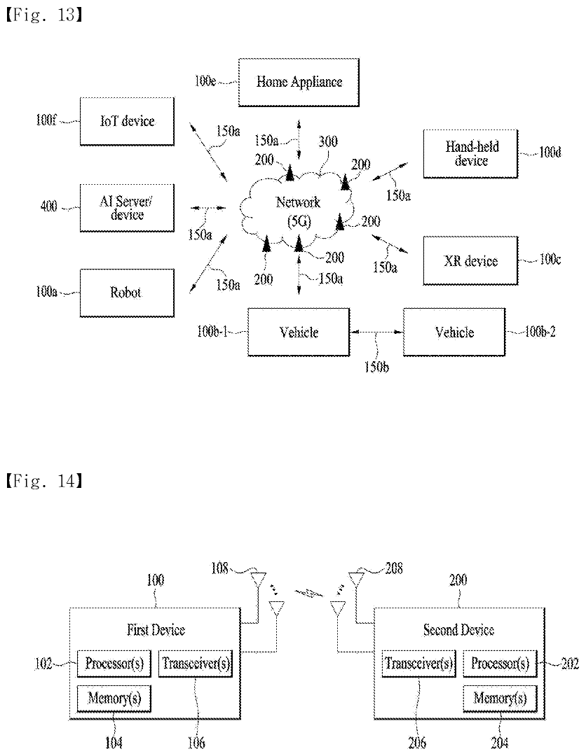

FIG. 14 illustrates wireless devices applicable to the present disclosure.

Referring to FIG. 14, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 13.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more service data unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

Examples of Signal Process Circuit Applicable to the Present Disclosure

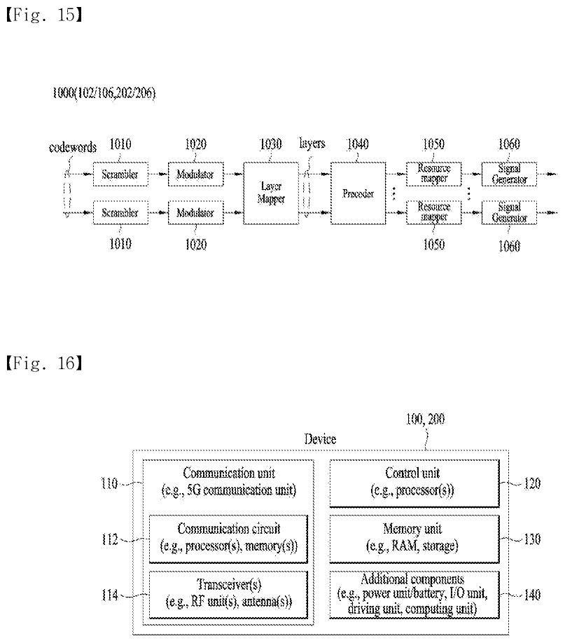

FIG. 15 illustrates a signal process circuit for a transmission signal.

Referring to FIG. 15, a signal processing circuit 1000 may include scramblers 1010, modulators 1020, a layer mapper 1030, a precoder 1040, resource mappers 1050, and signal generators 1060. An operation/function of FIG. 14 may be performed, without being limited to, the processors 102 and 202 and/or the transceivers 106 and 206 of FIG. 14. Hardware elements of FIG. 15 may be implemented by the processors 102 and 202 and/or the transceivers 106 and 206 of FIG. 14. For example, blocks 1010 to 1060 may be implemented by the processors 102 and 202 of FIG. 14. Alternatively, the blocks 1010 to 1050 may be implemented by the processors 102 and 202 of FIG. 14 and the block 1060 may be implemented by the transceivers 106 and 206 of FIG. 14.

Codewords may be converted into radio signals via the signal processing circuit 1000 of FIG. 15. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers 1010. Scramble sequences used for scrambling may be generated based on an initialization value, and the initialization value may include ID information of a wireless device. The scrambled bit sequences may be modulated to modulation symbol sequences by the modulators 1020. A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper 1030. Modulation symbols of each transport layer may be mapped (precoded) to corresponding antenna port(s) by the precoder 1040. Outputs z of the precoder 1040 may be obtained by multiplying outputs y of the layer mapper 1030 by an N*M precoding matrix W. Herein, N is the number of antenna ports and M is the number of transport layers. The precoder 1040 may perform precoding after performing transform precoding (e.g., DFT) for complex modulation symbols. Alternatively, the precoder 1040 may perform precoding without performing transform precoding.

The resource mappers 1050 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 1060 may generate radio signals from the mapped modulation symbols and the generated radio signals may be transmitted to other devices through each antenna. For this purpose, the signal generators 1060 may include IFFT modules, CP inserters, digital-to-analog converters (DACs), and frequency up-converters.

Signal processing procedures for a signal received in the wireless device may be configured in a reverse manner of the signal processing procedures 1010 to 1060 of FIG. 44. For example, the wireless devices (e.g., 100 and 200 of FIG. 43) may receive radio signals from the exterior through the antenna ports/transceivers. The received radio signals may be converted into baseband signals through signal restorers. To this end, the signal restorers may include frequency DL converters, analog-to-digital converters (ADCs), CP remover, and FFT modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

Examples of Application of Wireless Device Applicable to the Present Disclosure

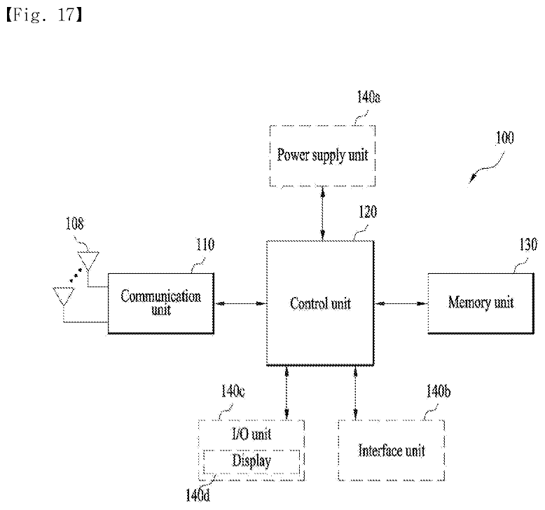

FIG. 16 illustrates another example of a wireless device applied to the present disclosure. The wireless device may be implemented in various forms according to a use-case/service (refer to FIG. 13).

Referring to FIG. 16, wireless devices 100 and 200 may correspond to the wireless devices 100 and 200 of FIG. 43 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 14. For example, the transceiver(s) 114 may include the one or more transceivers 106 and 206 and/or the one or more antennas 108 and 208 of FIG. 14. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 13), the vehicles (100b-1 and 100b-2 of FIG. 13), the XR device (100c of FIG. 13), the hand-held device (100d of FIG. 13), the home appliance (100e of FIG. 13), the IoT device (100f of FIG. 13), a digital broadcast terminal, a hologram device, a public safety device, an MTC device, a medicine device, a FinTech device (or a finance device), a security device, a climate/environment device, the AI server/device (400 of FIG. 13), the BSs (200 of FIG. 13), a network node, etc. The wireless device may be used in a mobile or fixed place according to a use-example/service.

In FIG. 16, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an electronic control unit (ECU), a graphical processing unit, and a memory control processor. As another example, the memory 130 may be configured by a RAM, a DRAM, a ROM, a flash memory, a volatile memory, a non-volatile memory, and/or a combination thereof.

Hereinafter, an example of implementing FIG. 16 will be described in detail with reference to the drawings.

Examples of a Hand-Held Device Applicable to the Present Disclosure

FIG. 17 illustrates a hand-held device applied to the present disclosure. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a mobile subscriber station (MSS), a subscriber station (SS), an advanced mobile station (AMS), or a wireless terminal (WT).

Referring to FIG. 17, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. 44, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an application processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

Examples of a Vehicle or an Autonomous Driving Vehicle Applicable to the Present Disclosure

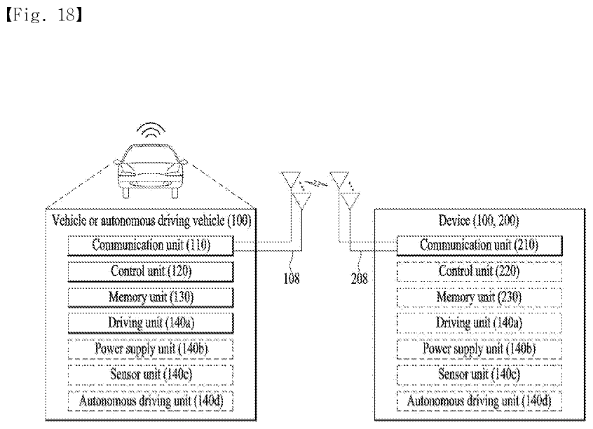

FIG. 18 illustrates a vehicle or an autonomous driving vehicle applied to the present disclosure. The vehicle or autonomous driving vehicle may be implemented by a mobile robot, a car, a train, a manned/unmanned aerial vehicle (AV), a ship, etc.

Referring to FIG. 18, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 16, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an ECU. The driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an inertial measurement unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

Examples of a Vehicle and AR/VR Applicable to the Present Disclosure

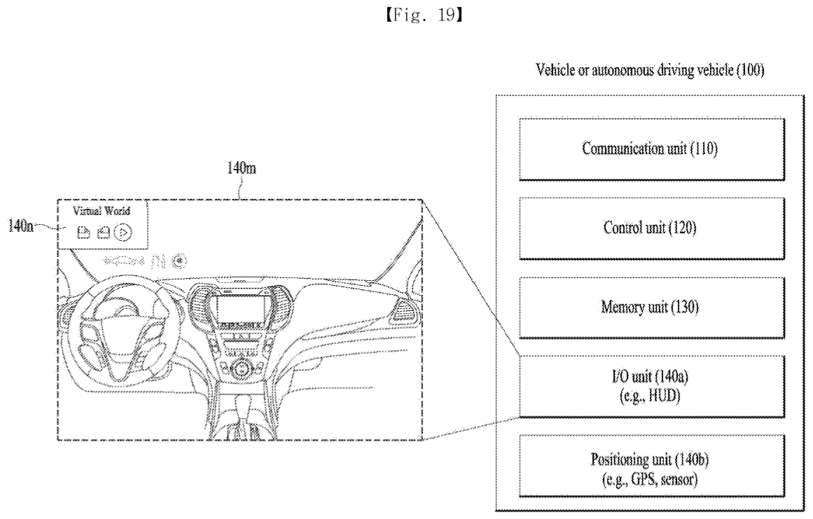

FIG. 19 illustrates a vehicle applied to the present disclosure. The vehicle may be implemented as a transport means, an aerial vehicle, a ship, etc.

Referring to FIG. 19, a vehicle 100 may include a communication unit 110, a control unit 120, a memory unit 130, an I/O unit 140a, and a positioning unit 140b. Herein, the blocks 110 to 130/140a and 140b correspond to blocks 110 to 130/140 of FIG. 16.

The communication unit 110 may transmit and receive signals (e.g., data and control signals) to and from external devices such as other vehicles or BSs. The control unit 120 may perform various operations by controlling constituent elements of the vehicle 100. The memory unit 130 may store data/parameters/programs/code/commands for supporting various functions of the vehicle 100. The I/O unit 140a may output an AR/VR object based on information within the memory unit 130. The I/O unit 140a may include an HUD. The positioning unit 140b may acquire information about the position of the vehicle 100. The position information may include information about an absolute position of the vehicle 100, information about the position of the vehicle 100 within a traveling lane, acceleration information, and information about the position of the vehicle 100 from a neighboring vehicle. The positioning unit 140b may include a GPS and various sensors.

As an example, the communication unit 110 of the vehicle 100 may receive map information and traffic information from an external server and store the received information in the memory unit 130. The positioning unit 140b may obtain the vehicle position information through the GPS and various sensors and store the obtained information in the memory unit 130. The control unit 120 may generate a virtual object based on the map information, traffic information, and vehicle position information and the I/O unit 140a may display the generated virtual object in a window in the vehicle (1410 and 1420). The control unit 120 may determine whether the vehicle 100 normally drives within a traveling lane, based on the vehicle position information. If the vehicle 100 abnormally exits from the traveling lane, the control unit 120 may display a warning on the window in the vehicle through the I/O unit 140a. In addition, the control unit 120 may broadcast a warning message regarding driving abnormity to neighboring vehicles through the communication unit 110. According to situation, the control unit 120 may transmit the vehicle position information and the information about driving/vehicle abnormality to related organizations.

Examples of an XR Device Applicable to the Present Disclosure

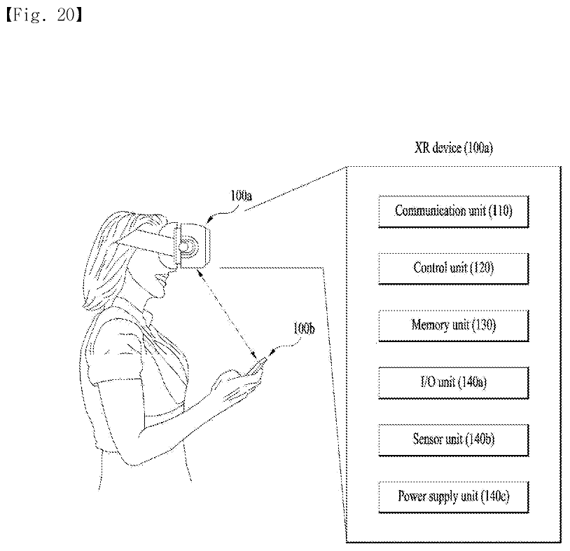

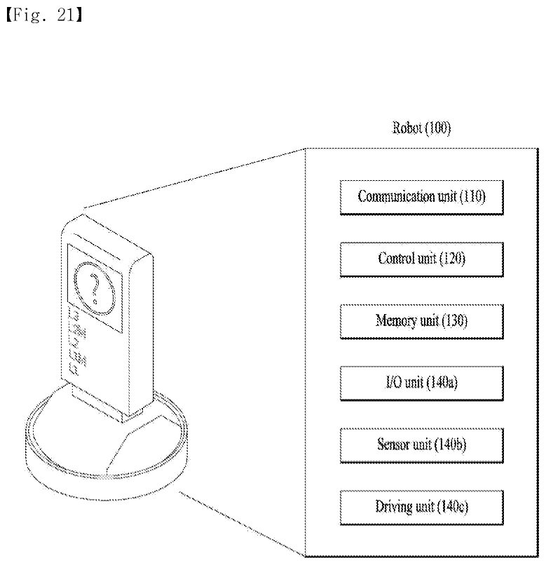

FIG. 20 illustrates an XR device applied to the present disclosure. The XR device may be implemented by an HMD, an HUD mounted in a vehicle, a television, a smartphone, a computer, a wearable device, a home appliance, a digital signage, a vehicle, a robot, etc.

Referring to FIG. 20, an XR device 100a may include a communication unit 110, a control unit 120, a memory unit 130, an I/O unit 140a, a sensor unit 140b, and a power supply unit 140c. Herein, the blocks 110 to 130/140a to 140c correspond to the blocks 110 to 130/140 of FIG. 16, respectively.

The communication unit 110 may transmit and receive signals (e.g., media data and control signals) to and from external devices such as other wireless devices, hand-held devices, or media servers. The media data may include video, images, and sound. The control unit 120 may perform various operations by controlling constituent elements of the XR device 100a. For example, the control unit 120 may be configured to control and/or perform procedures such as video/image acquisition, (video/image) encoding, and metadata generation and processing. The memory unit 130 may store data/parameters/programs/code/commands needed to drive the XR device 100a/generate XR object. The I/O unit 140a may obtain control information and data from the exterior and output the generated XR object. The I/O unit 140a may include a camera, a microphone, a user input unit, a display unit, a speaker, and/or a haptic module. The sensor unit 140b may obtain an XR device state, surrounding environment information, user information, etc. The sensor unit 140b may include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, a light sensor, a microphone and/or a radar. The power supply unit 140c may supply power to the XR device 100a and include a wired/wireless charging circuit, a battery, etc.

For example, the memory unit 130 of the XR device 100a may include information (e.g., data) needed to generate the XR object (e.g., an AR/VR/MR object). The I/O unit 140a may receive a command for manipulating the XR device 100a from a user and the control unit 120 may drive the XR device 100a according to a driving command of a user. For example, when a user desires to watch a film or news through the XR device 100a, the control unit 120 transmits content request information to another device (e.g., a hand-held device 100b) or a media server through the communication unit 130. The communication unit 130 may download/stream content such as films or news from another device (e.g., the hand-held device 100b) or the media server to the memory unit 130. The control unit 120 may control and/or perform procedures such as video/image acquisition, (video/image) encoding, and metadata generation/processing with respect to the content and generate/output the XR object based on information about a surrounding space or a real object obtained through the I/O unit 140a/sensor unit 140b.

The XR device 100a may be wirelessly connected to the hand-held device 100b through the communication unit 110 and the operation of the XR device 100a may be controlled by the hand-held device 100b. For example, the hand-held device 100b may operate as a controller of the XR device 100a. To this end, the XR device 100a may obtain information about a 3D position of the hand-held device 100b and generate and output an XR object corresponding to the hand-held device 100b.

Examples of a Robot Applicable to the Present Disclosure

FIG. 21 illustrates a robot applied to the present disclosure. The robot may be categorized into an industrial robot, a medical robot, a household robot, a military robot, etc., according to a used purpose or field.

Referring to FIG. 21, a robot 100 may include a communication unit 110, a control unit 120, a memory unit 130, an I/O unit 140a, a sensor unit 140b, and a driving unit 140c. Herein, the blocks 110 to 130/140a to 140c correspond to the blocks 110 to 130/140 of FIG. 45, respectively.

The communication unit 110 may transmit and receive signals (e.g., driving information and control signals) to and from external devices such as other wireless devices, other robots, or control servers. The control unit 120 may perform various operations by controlling constituent elements of the robot 100. The memory unit 130 may store data/parameters/programs/code/commands for supporting various functions of the robot 100. The I/O unit 140a may obtain information from the exterior of the robot 100 and output information to the exterior of the robot 100. The I/O unit 140a may include a camera, a microphone, a user input unit, a display unit, a speaker, and/or a haptic module. The sensor unit 140b may obtain internal information of the robot 100, surrounding environment information, user information, etc. The sensor unit 140b may include a proximity sensor, an illumination sensor, an acceleration sensor, a magnetic sensor, a gyro sensor, an inertial sensor, an IR sensor, a fingerprint recognition sensor, an ultrasonic sensor, a light sensor, a microphone, a radar, etc. The driving unit 140c may perform various physical operations such as movement of robot joints. In addition, the driving unit 140c may cause the robot 100 to travel on the road or to fly. The driving unit 140c may include an actuator, a motor, a wheel, a brake, a propeller, etc.

Example of AI Device Applicable to the Present Disclosure

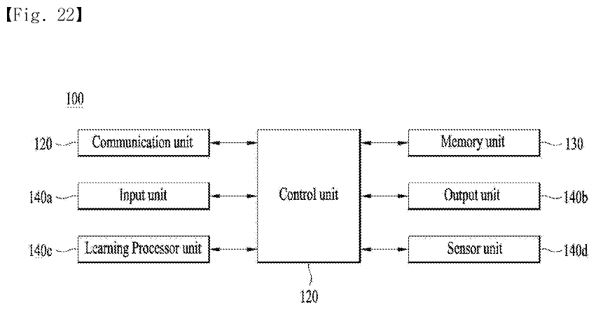

FIG. 22 illustrates an AI device applied to the present disclosure. The AI device may be implemented by a fixed device or a mobile device, such as a TV, a projector, a smartphone, a PC, a notebook, a digital broadcast terminal, a tablet PC, a wearable device, a Set Top Box (STB), a radio, a washing machine, a refrigerator, a digital signage, a robot, a vehicle, etc.

Referring to FIG. 22, an AI device 100 may include a communication unit 110, a control unit 120, a memory unit 130, an I/O unit 140a/140b, a learning processor unit 140c, and a sensor unit 140d. The blocks 110 to 130/140a to 140d correspond to blocks 110 to 130/140 of FIG. 44, respectively.

The communication unit 110 may transmit and receive wired/radio signals (e.g., sensor information, user input, learning models, or control signals) to and from external devices such as other AI devices (e.g., 100x, 200, or 400 of FIG. 13) or an AI server (e.g., 400 of FIG. 13) using wired/wireless communication technology. To this end, the communication unit 110 may transmit information within the memory unit 130 to an external device and transmit a signal received from the external device to the memory unit 130.

The control unit 120 may determine at least one feasible operation of the AI device 100, based on information which is determined or generated using a data analysis algorithm or a machine learning algorithm. The control unit 120 may perform an operation determined by controlling constituent elements of the AI device 100. For example, the control unit 120 may request, search, receive, or use data of the learning processor unit 140c or the memory unit 130 and control the constituent elements of the AI device 100 to perform a predicted operation or an operation determined to be preferred among at least one feasible operation. The control unit 120 may collect history information including the operation contents of the AI device 100 and operation feedback by a user and store the collected information in the memory unit 130 or the learning processor unit 140c or transmit the collected information to an external device such as an AI server (400 of FIG. 13). The collected history information may be used to update a learning model.

The memory unit 130 may store data for supporting various functions of the AI device 100. For example, the memory unit 130 may store data obtained from the input unit 140a, data obtained from the communication unit 110, output data of the learning processor unit 140c, and data obtained from the sensor unit 140. The memory unit 130 may store control information and/or software code needed to operate/drive the control unit 120.

The input unit 140a may acquire various types of data from the exterior of the AI device 100. For example, the input unit 140a may acquire learning data for model learning, and input data to which the learning model is to be applied. The input unit 140a may include a camera, a microphone, and/or a user input unit. The output unit 140b may generate output related to a visual, auditory, or tactile sense. The output unit 140b may include a display unit, a speaker, and/or a haptic module. The sensing unit 140 may obtain at least one of internal information of the AI device 100, surrounding environment information of the AI device 100, and user information, using various sensors. The sensor unit 140 may include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, a light sensor, a microphone, and/or a radar.

The learning processor unit 140c may learn a model consisting of artificial neural networks, using learning data. The learning processor unit 140c may perform AI processing together with the learning processor unit of the AI server (400 of FIG. 13). The learning processor unit 140c may process information received from an external device through the communication unit 110 and/or information stored in the memory unit 130. In addition, an output value of the learning processor unit 140c may be transmitted to the external device through the communication unit 110 and may be stored in the memory unit 130.

### INDUSTRIAL APPLICABILITY

The above-described embodiments of the present disclosure are applicable to various mobile communication systems.

1.-13. (canceled)

14. A method for transmitting data by a first user equipment (UE) in a wireless communication system, the method comprising:
receiving, by a radio layer of the first UE, the data from a higher layer of the first UE;
monitoring radio link with a second UE;
declaring Radio Link Failure (RLF) based on a result of the monitoring of the radio link;
determining the data as available data for transmission based on the radio link being recovered within a time duration, and
determining the data as unavailable data for transmission based on the radio link not being recovered within the time duration.

15. The method of claim 14, wherein a Buffer Status Report (BSR) for the data is not triggered based on the radio link not being recovered within the time duration.

16. The method of claim 14, wherein an indication indicating the data as available data for transmission is not delivered to a lower layer based on the radio link not being recovered within the time duration.

17. The method of claim 16, wherein the lower layer is Media Access Control (MAC) layer.

18. The method of claim 14, wherein a Buffer Status Report (BSR) for the data is triggered based on the radio link being recovered within the time duration.

19. The method of claim 18, wherein a resource for the data is allocated based on the BSR.

20. A first user equipment (UE) for transmitting data in a wireless communication system, the first UE comprising:
at least one transceiver;
at least one processor; and
at least one computer memory operably connectable to the at least one processor and storing instructions that, when executed, cause the at least one processor to perform operations comprising:
receiving, by a radio layer of the first UE, the data from a higher layer of the first UE;
monitoring radio link with a second UE;
declaring Radio Link Failure (RLF) based on a result of the monitoring of the radio link;
determining the data as available data for transmission based on the radio link being recovered within a time duration, and
determining the data as unavailable data for transmission based on the radio link not being recovered within the time duration.

21. The first UE of claim 20, wherein a Buffer Status Report (BSR) for the data is not triggered based on the radio link not being recovered within the time duration.

22. The first UE of claim 20, wherein an indication indicating the data as available data for transmission is not delivered to a lower layer based on the radio link not being recovered within the time duration.

23. The first UE of claim 22, wherein the lower layer is Media Access Control (MAC) layer.

24. The first UE of claim 20, wherein a Buffer Status Report (BSR) for the data is triggered based on the radio link being recovered within the time duration.

25. The first UE of claim 24, wherein a resource for the data is allocated based on the BSR.

26. An apparatus for transmitting data in a wireless communication system, the apparatus comprising:
at least one processor; and
at least one computer memory operably connectable to the at least one processor and storing instructions that, when executed, cause the at least one processor to perform operations comprising:
receiving, by a radio layer of the apparatus, the data from a higher layer of the apparatus;
monitoring radio link with other apparatus;
declaring Radio Link Failure (RLF) based on a result of the monitoring of the radio link;
determining the data as available data for transmission based on the radio link being recovered within a time duration, and
determining the data as unavailable data for transmission based on the radio link not being recovered within the time duration.

27. A computer readable storage medium storing at least one computer program comprising instructions that, when executed by at least one processor, cause the at least one processor to perform operations, the operations comprising:
receiving, by a radio layer of the first UE, the data from a higher layer of the first UE;
monitoring radio link with other apparatus;
declaring Radio Link Failure (RLF) based on a result of the monitoring of the radio link;
determining the data as available data for transmission based on the radio link being recovered within a time duration, and
determining the data as unavailable data for transmission based on the radio link not being recovered within the time duration.
